(19) United States
(12) Patent Application Publication
(10) Pub. No.: US 2005/0026685 A1
(43) Pub. Date: Feb. 3, 2005

(54) Customizing players in a video game using morphing from morph targets and other elements

(75) Inventors: Holly Lynn Ruark, Belmont, CA (US); Sandra Mae Voelker, San Francisco, CA (US); Ryan Eric Ingram, San Francisco, CA (US); Mike Ryan Olsen, San Mateo, CA (US); James Gill Brooks, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronic Arts Inc., Redwood City, CA (US)

(21) Appl. No.: 10/846,950

(22) Filed: May 13, 2004

Related U.S. Application Data
(60) Provisional application No. 60/469,999, filed on May 13, 2003.

(51) Int. Cl. G06F 19/00

(52) U.S. Cl. 463/31

(57) ABSTRACT

In a video game, a player is allowed to create a character in the video game by selecting feature variables that define a character feature according to two or more target features and a feature variable. The target features can be are morph targets and the feature variable might represent relative distance of the player's desired feature relative to the morph targets. In a specific example, the player might be presented with two face shapes as morph targets and an input slider for a corresponding feature variable where the resulting face feature of the character matches one of the morph targets when the input slider is at one extreme, matches the other morph target when the input slider is at the other extreme and is a combination of the morph targets when the input slider is between the extremes. The character features might include face shape, height, weight, skin color, skin texture, body build, particular sports figures' faces, clothing, hair, eyes, nose, mouth, lips, hands, feet, etc. The player can also purchase items from a shop according to restrictions on cost, sponsorship, availability, time of day, date and/or day of year.

### CROSS-REFERENCE TO RELATED APPLICATIONS

This application claims priority from co-pending U.S. Provisional Patent Application No. 60/469,999 filed May 13, 2003 entitled CUSTOMIZING PLAYERS IN A VIDEO GAME USING MORPHING FROM MORPH TARGETS AND OTHER ELEMENTS which is hereby incorporated by reference, as if set forth in full in this document, for all purposes.

### FIELD OF THE INVENTION

The present invention relates generally to video games and in particular to video games having players with customizable attributes.

### BACKGROUND OF THE INVENTION

Character-based video games typically involve a player manipulating one or more game characters according to some strategy to achieve game goals or to interact with the game environment to perform tasks or other game interactions. For example, in a golf video game, the player might manipulate inputs to control a golfer game character such that the golf game character golfs well, measured by scores, sponsorships, titles, etc. In some games, one player controls one character. In other games, more than one player play and each controls one distinct character. In yet other games, one or more players each control one or more character.

Character customization adds interest to a game. With character customization, a player can specify features of his or her character(s) and those features would be maintained through out the play of a game and possibly saved as features to be used in later games. Features might include objects, such as a hat of a particular style, a particular shirt, etc., that appear as part of the character's overall appearance. Other features might include objects that the character “owns” or controls, such as golf clubs, swords, shields, magic scrolls, cars, household items, and the like.

Video games with customizable characters are known. For example, a video game program might include a “front end” module to allow a player to select various game settings, such as a level of difficulty, ability to save/load a game, and select a character. In some games, the player selects from a predefined set of characters, such as a small set of predefined game pieces (e.g., hat, dog, man, woman, wizard, captain) or predefined game characters (e.g., particular athletes that have licensed their likenesses to the game developer). In other games, the player can pick character features and combine them. For example, in Electronic Arts' “The Sims™ Deluxe™” simulation video game, using its “The Sims™ Creator™” program feature, a player can select one of a plurality of bodies, one of a plurality of hairdos, one of a plurality of shirts, etc., to form a character for that player to use. In either case, the player is limited to a character that is either one of a set of predetermined characters, or a character built from a predetermined set of components.

Some players will want to have a character that is unique with respect to all other characters appearing in the game for that player. With a game having only four distinct players and four or more predefined game characters, it is a simple matter for each of the players to select a unique predefined game character. However, where many or an unlimited number of characters might appear in the game for a particular player, the game program would be needed to store a number of predefined game characters that is at least as a numerous as the number of characters that might appear in order for each character to be unique. In on-line games, where a player's character might encounter characters from hundreds or thousands of other players, it is simply not feasible for a game program to ship with enough predefined game characters for each player to be able to select a unique character. Even where a player selects from predefined sets for each of a plurality of character features, there might not be enough combinations of character features to allow each a player to have a unique character and, even if enough combinations are available, certain combinations among the limited set might end up being used over and over by different players.

In addition to ensuring that each player can have a unique character if desired, some players might want further customization then is allowed by selecting among predefined possibilities.

It would be desirable to overcome the shortcomings of the prior art described above.

### BRIEF SUMMARY OF THE INVENTION

In one embodiment of a video game according to the present invention, a player is allowed to create a character in the video game by selecting feature variables that define a character feature according to two or more target features and a feature variable. In a specific embodiment, the target features are morph targets and the feature variable represents relative distance of the player's desired feature relative to the morph targets. In a specific example, the player might be presented with two face shapes as morph targets and an input slider for a corresponding feature variable where the resulting face feature of the character matches one of the morph targets when the input slider is at one extreme, matches the other morph target when the input slider is at the other extreme and is a combination of the morph targets when the input slider is between the extremes.

The character features might include face shape, height, weight, skin color, skin texture, body build, particular sports figures' faces, clothing, hair, eyes, nose, mouth, lips, hands, feet, etc.

The player can also purchase items from a shop according to restrictions on cost, sponsorship, availability, time of day, date and/or day of year.

A further understanding of the nature and the advantages of the inventions disclosed herein may be realized by reference to the remaining portions of the specification and the attached drawings.

### BRIEF DESCRIPTION OF THE DRAWINGS

FIG. 1 is a block diagram of a game system for use with various aspects of the present invention.

FIG. 2 is a block diagram of data elements and process elements for player customizations.

FIG. 3 is a block diagram showing elements of FIG. 2 in greater detail.

FIG. 4 is a block diagram illustrating some of the elements of a data memory of the game system.

FIG. 5 is a block diagram illustrating some of the elements of an instruction memory of the game system.

FIG. 6 is an illustration of a player placard as might be used to present player details to a user, including customized features.

FIG. 7 is an illustration of a reverse side of the player placard of FIG. 6 illustrating examples of categories of customizable features.

FIG. 8 is an illustration of a reverse side of the player placard of FIG. 6 illustrating customizable features of some categories.

FIG. 9 is an illustration of a reverse side of the player placard of FIG. 6 illustrating customizable features of some other categories.

FIG. 10 is an illustration of various morph targets for body type.

### DETAILED DESCRIPTION OF THE INVENTION

A game character can be customized using morph targets. The morph targets might be associated with specific character features, such that a player can separately specify a feature variable for separate character features. In the example used herein, a player specifies a feature variable by positioning a slider bar and immediately viewing the result of repositioning the slider bar. In other variations, the immediate visual feedback might not be present and input mechanisms other than a slider bar right be used, such as a dialog box for in entering a number.

In the examples used herein, it will often be assumed that the slider bar has a range from one extreme that corresponds to one morph target and another extreme that corresponds to another morph target. However it should be understood that other variations might be used, such as allowing the slider bar to extend beyond one or both of the morph targets. As an example, suppose that a first morph target were associated with a slider bar position of 0 and a second morph target were associated with the slider bar position of 1. In one embodiment, the feature variable would be constrained to be of value between 0 and 1 inclusive, but in other embodiments the feature variable might be less than zero or greater than one.

The character features might relate to locations and/or sizes for bones, vertices, textures and character elements such as hats, socks etc. Character features can be independent but might also be interdependent, such as where a hat selection affects the appearance of a hair selection.

To get a player involved in the game quickly, a game front end might provide a menu selection for the player to create a character and when selected begin with a preselected set of feature values. The preselected set of feature values might be random or pseudorandom, such that different players begin with different initial feature values, thus resulting in different characters even if each of the different players accepts the character that results from the initial feature values. For illustration of purposes, the character creation process might present to the user an animation wherein the feature values (e.g., slider positions) are varied randomly to present the player with a sampling of possible characters.

In another variation of the character creation process, the initial character is a wireframe that becomes textured as the user makes selections for various character features. The wireframe can be either an actual wireframe from a geometric model for the character or it can be a wireframe texture applied over the wireframe of the geometric model. The wireframe texture is useful where the actual wireframe is too dense or not aesthetic.

While the player's character can be manipulated in the game as a set of a morph targets and feature values indicating where in a “morph space” the player's character falls, it would be more efficient and compatible to have generated at the front end a character that appears as the player has created with the morph targets and feature values distilled out of the character model. In effect, if the process of morphing is a clay molding process, then the distillation process can be thought of as a “baking” process. Once the player's selection is “baked”, the character model can be treated by the game just like any other character.

In addition to morphing, some character features can be scaled, such as by modifying the length of the player's arms when the overall size of the player is adjusted.

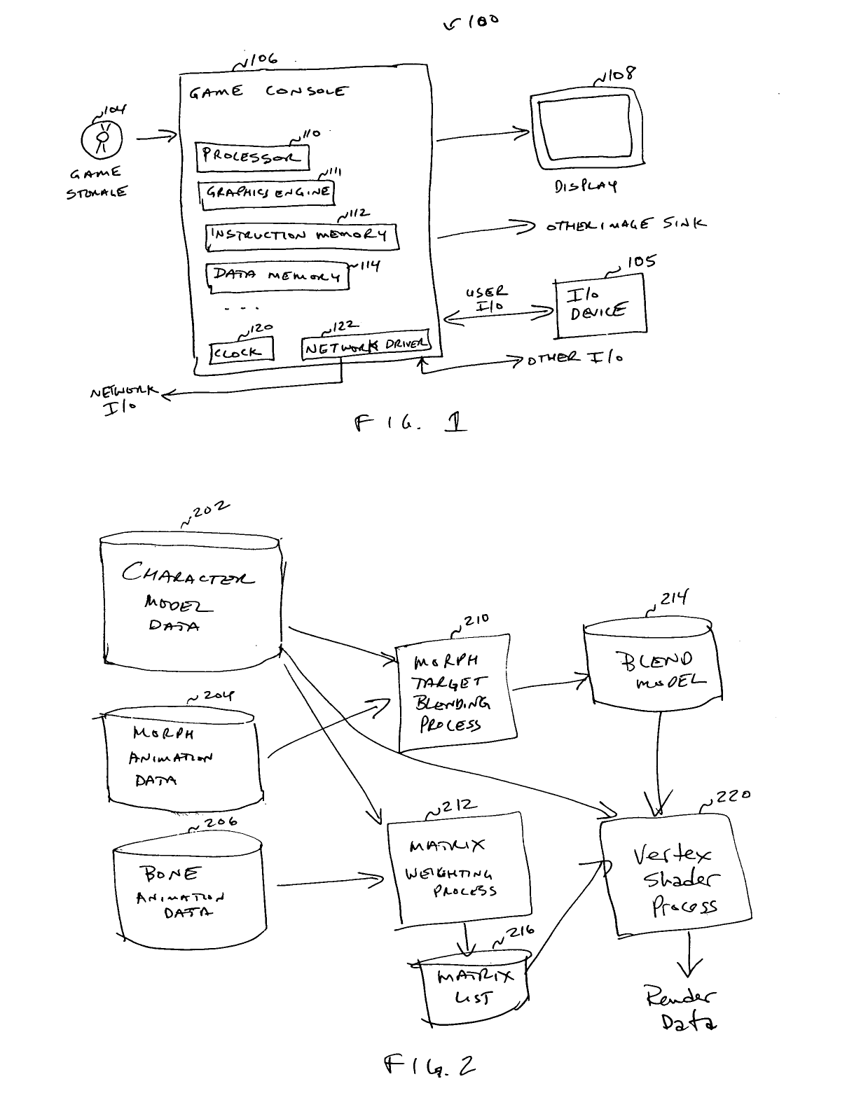

Referring now to the figures, FIG. 1 illustrates a game system 100 for use with various aspects of the present invention. Game system 100 generates game data, stores game data, interacts with the user and generates images for presentation by the game system according to aspects of the present invention. Other variations should be apparent upon review of this disclosure. Game console 106 receives as input game data from game storage 104. Although the example of game storage 104 is illustrated as a CD-ROM, it should be apparent that other storage media could also be used. Game console 106 might also obtain game data or other data from network I/O via a network driver 122 or other I/O. Game console 106 can obtain user input via I/O device 105, which can be a game controller, a keyboard, another computer, etc. Game console presents images, including customized player views in display 108 and can provide the images to other image sinks.

Game storage 104 can provide the necessary information for a game console 106 to execute a video game including presentation of suitable images of the player, operate the game according to preprogrammed rules, etc. An example of some components of game console 106 are shown in FIG. 1 including a processor 110, a graphics engine 111, instruction memory 112 for storing game instructions provided by game storage 104 or other sources, and data memory 114 for storing data provided by game storage 104 or other sources or data generated during the operation of game console 106.

FIG. 2 is a block diagram of data elements and process elements for player customizations, including character model data 202, morph animation data 204, bone animation data 206, a morph target blending process 210, a matrix weighting process 212, a blend model 214, a matrix list 216 and a vertex shader process 220. As shown, morph target blending process 210 processes data to generate blend model 214 and matrix weighting process 212 processes data to generate matrix list 216, which are used in vertex shading to provide an output to a rendering engine.

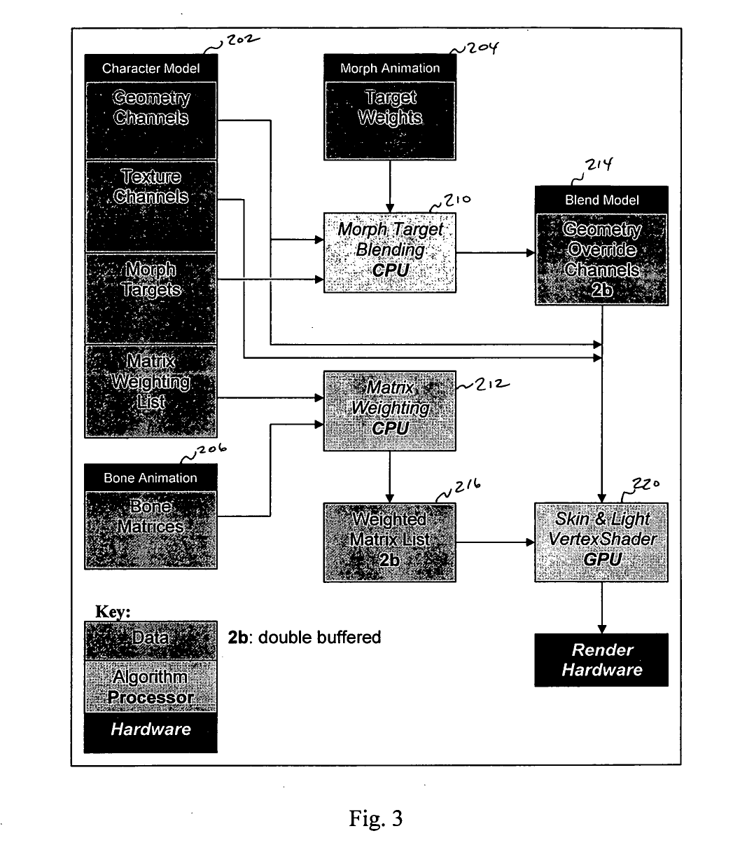

FIG. 3 is a block diagram showing elements of FIG. 2 in greater detail. The hardware that executes processes 210, 212 and 220 is indicated (CPU, GPU), but other allocations of processes might be used instead.

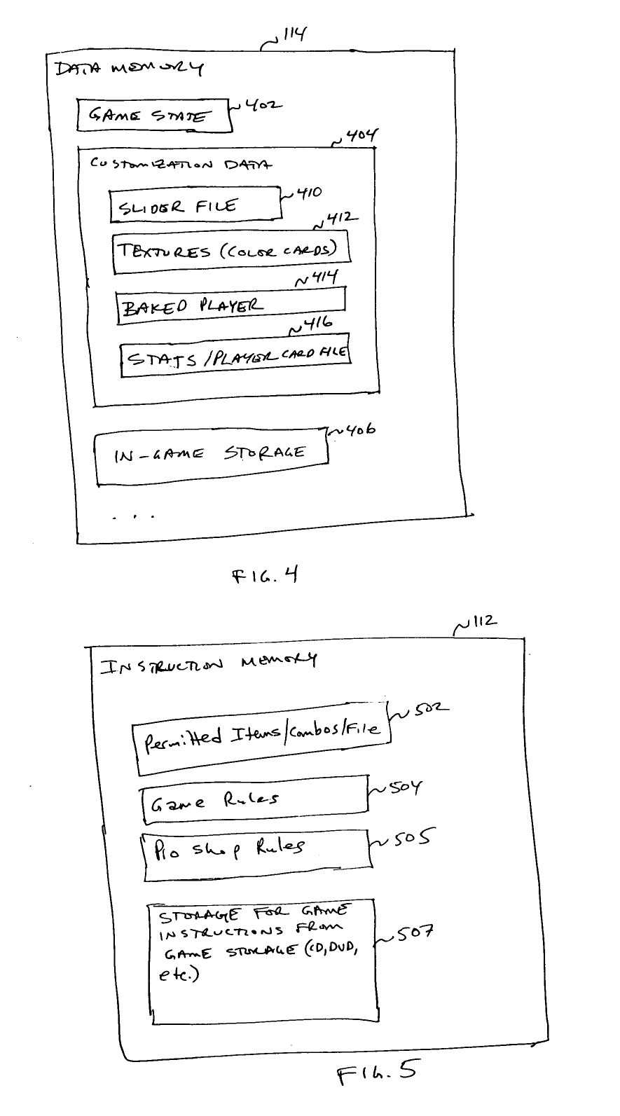

Referring now to FIG. 4, elements of data memory 114 are shown. These elements can be populated with data generated by the game console, loaded from game storage 104, or otherwise provided to the game console. Data memory 114 is shown including storage for game state 402, customization data 404 and in-game storage 406 for use in storing data that is needed while a game is active, but not necessarily when the game is not active (such as during a front end process of setting up for running a game, customizing players, etc.).

Customization data 404 is shown including a slider file 410 for containing slider value settings, where slider value settings indicate the user's preferred position in a selection space that is used to weight a plurality of morph targets to be combined into customized features of the player. Also shown is storage for textures 412, as might be used according to the teachings of U.S. Pat. No. ______ [Attorney docket 019491-008910US filed of even date herewith.] Storage 414 is provided for a “baked” player model. This model can be of the same format as uncustomized player models and stored as efficiently as an uncustomized player model, albeit with all the abilities to customize further. Since player customization is not normally expected while a game is afoot, the “baking” process does not unduly limit user options. Storage 416 for stats/player card data is also provided. Stats might include past performances and be used for unlocking features only available to more advanced players.

FIG. 5 is a block diagram illustrating some of the elements of an instruction memory of the game system, which might be populated from game storage 104. As shown, instruction memory 112 includes storage 502 for permitted items/combinations, storage 504 for game rules, storage 505 for pro shop (or other shopping game elements) rules and storage 507 for game instructions from game storage 104 that are loaded as needed.

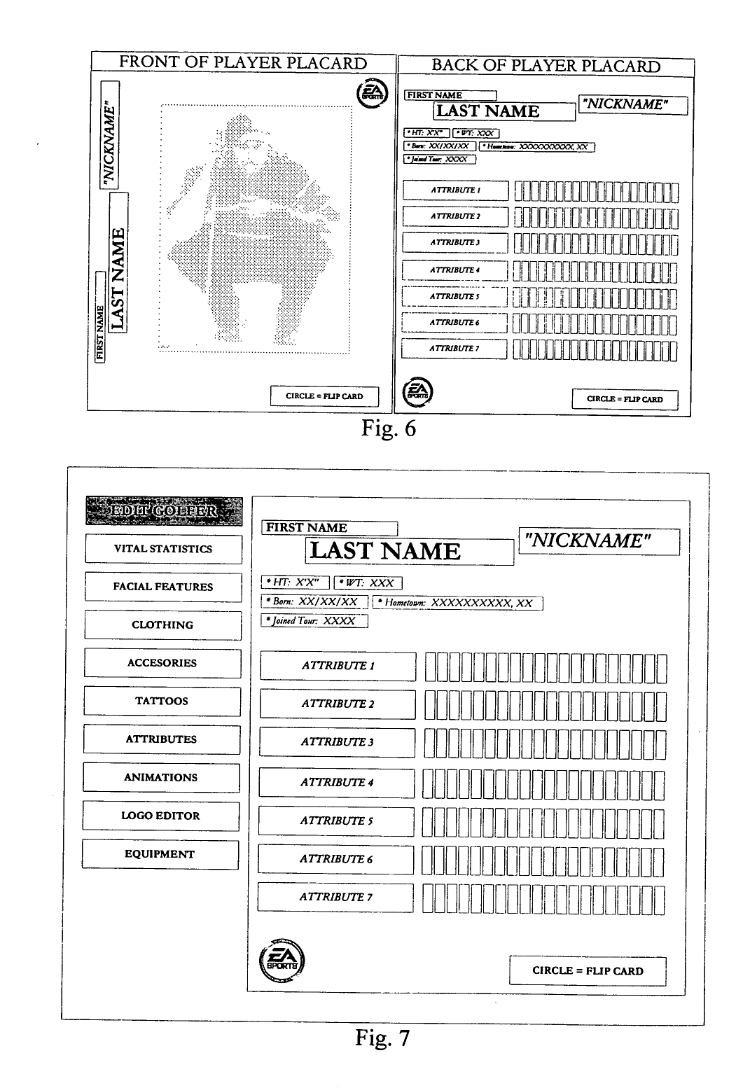

FIG. 6 is an illustration of a player placard as might be used to present player details to a user, including customized features.

FIG. 7 is an illustration of a reverse side of the player placard of FIG. 6 illustrating examples of categories of customizable features.

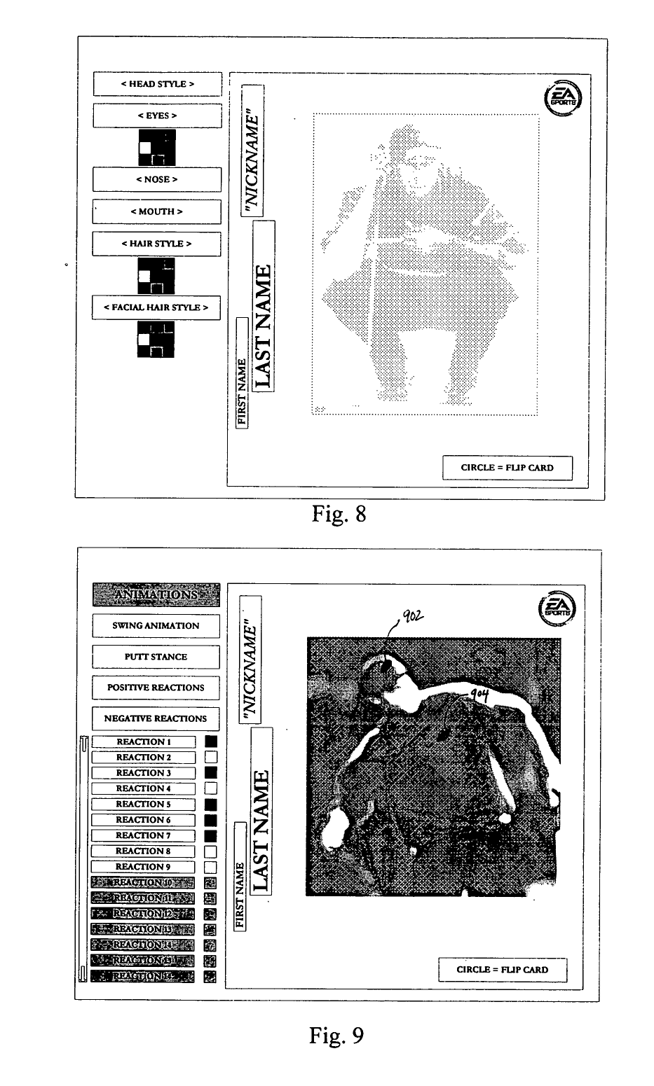

FIG. 8 is an illustration of a reverse side of the player placard of FIG. 6 illustrating customizable features of some categories.

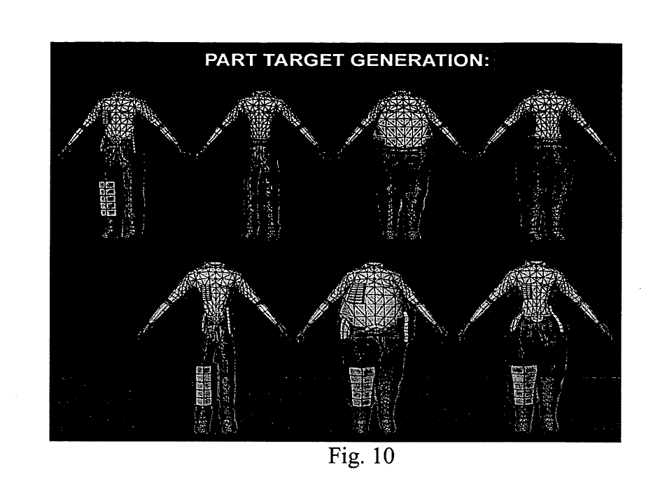

FIG. 9 is an illustration of a reverse side of the player placard of FIG. 6 illustrating customizable features of some other categories.

Some of the customizable features will now be described. In one implementation, the player might be able to adjust the shape of various sections of the body, using various slider configurations (Athletic, Thin, and Fat), adjust the shape of the head/face using sliders that affect the overall shape of the head/face, along with sliders that change the look of regions on the face (Nose, Eyes, Brows, and Lips/Mouth), scale the head within a given threshold along the x, y and z axes, select a face texture (with scars, freckles, moles, wrinkles, etc.) pre-baked into certain textures, select facial hair style, color and skin tone from a predetermined list of palettes, etc. In addition to body features, articles of clothing can be selected. Some combinations would only be allowed for users who have players with certain levels of skills. For example, a tour logo would only be available to users who have achieved “tour” status for their player.

Creating a Customized Character

To create a customized character, the game console presents the user with a display such as that shown in FIG. 8. The user can manipulate sliders or other controls to adjust weights of morph objects, sizes, colors, etc., or simply to select objects (such as articles of clothing, equipment, etc.) Some settings are overall settings, such as build, and some are individual settings, such as hair style, pant color, etc. As an example, the user might adjust a slider control to form a base character between a thin morph target and a fat morph target. Various targets are illustrated in FIG. 10. Blending body shapes to create a unique physique can be expanded further by incorporating the ability to adjust specific body parts, such as controls that scale the shoulders, chest, biceps, forearms, and the lower body. For storing changes, only the vertex deltas might be stored for vertices in blend targets that move from the original base location, to save memory. Scaling might also be done on an in-game skeleton to achieve various physique changes. Targets can offer very detailed sculpting of the model's surface, only limited by the resolution of the geometry.

Scaling joints translate vertices outward from the joints to which they are bound, along the scaled axes. The scaling distance is derived from the percentage that those vertices are influenced by that joint. It is possible to get a nice-looking forearm, calf, foot, and head scaling using this method.

Pro Shop

A feature that might be provided in a game front end is a “pro shop” feature. With the pro shop feature, a player is given a default set of items to customize during the front end process, but additional items (clothing, equipment and accessories) can be later purchased in the pro shop. One aspect of the pro shop is that its availability and its contents might depend on the player's real-time system clock. As an example, the pro shop can be closed during certain times of the day and might carry seasonal offerings, such as thicker sweaters when the real-time system clock indicates that the current month is January. The available offerings might also depend on a player's level of achievement in the game and/or some accumulated value attributed to the player. Additional offerings might be available only to players having certain “sponsorships”.

Time-dependent features of the pro shop might include “daily specials” or sale rack items featured every 24 hours. These daily specials are items that are available at a discounted “price”. As the player progresses though the game, more items might become available for purchase in the pro shop. Factors such as game completion and sponsorships might affect the availability of items. With new items available, the player is able to customize/personalize his or her created character further.

With another pro shop feature, a grab bag method of purchasing items can be done. With this feature, unspecified items are available for purchase and buying a grab-bag item, the player is awarded an unknown item and this might give the player a chance to win an item that may be currently unavailable to that player or cost more than the player has currently available. The grab-bag logic might filter items so that a player does not receive duplicate items when purchasing grab-bags.

As previously mentioned, the pro shop will gain more items as the player progresses through the game. Based on game completion as well as sponsorships obtained, item availability will grow. One approach to selectivity is to assign items to tiers and players to tiers and only make available items at the player's tier or below. The number of tiers might be five. An example is shown in Table 1.

TABLE 1

| Player Level | Condition to Unlock |
|---|---|
| Tier 1 | None. Available at 1^{st} Boot. |
| Tier 2 | 15% Game Completion. |
| Tier 3 | 35% Game Completion. |
| Tier 4 | 55% Game Completion. |
| Tier 5 | 75% Game Completion. |

This means that there might be five tiers of clubs, balls, clothing and accessories in a golf pro shop. The first tier will have the “low-level” or introductory items of each category. When a new tier becomes available, the pro shop is “upgraded.” To signify to the player that an upgrade has occurred, the pro shop can be closed for a period of time (based on the real-time clock). Player rewards might include a change in the number of daily special items for every tier unlocked. For example, if the player has unlocked items up to Tier 3, the pro shop will have three daily specials available for purchase. Items available in the grab bag specials might scale based on the player's tier level.

The item(s) available in the daily special might be randomly chosen based on a current tier level. The pro shop might run out of daily specials and be replenished according to the clock a day-to-day basis. The inventory might be changed at midnight, for example.

The daily specials and the grab-bag specials might allow multiple purchases per visit. Daily specials could be valid for the day. Once the player has purchased a daily special, it remains empty until the next day. Grab-bags might be available for purchase repeatedly for player with cash to purchase them.

Since the grab bag will be an unknown (or apparently random) item awarded to the player, the randomization logic should support logic to avoid grab bag items that the player already has. Another constraint might be a formula for probabilities for items from various tiers. As the player progress through the game, the grab bag might scale in price as well as in value. Table 2 shows one example of grab-bag item probabilities for items at different tiers based on a player's tier.

TABLE 1

| | Item Level | | | | |
|---|---|---|---|---|---|
| Player Level | Tier 1 | Tier 2 | Tier 3 | Tier 4 | Tier 5 |
| Tier 1 | 90% | 7% | 3% | 0% | 0% |
| Tier 2 | 7% | 80% | 10% | 3% | 0% |
| Tier 3 | 2% | 5% | 80% | 10% | 3% |
| Tier 4 | 2% | 3% | 5% | 80% | 10% |
| Tier 5 | 1% | 2% | 3% | 4% | 90% |

The input to a character renderer might form three parts: 1) a character model containing vertex, bone weighting, texture, material, and morph target information. This will be used as a read-only buffer for information needed by the renderer, 2) The animation system will generate a list of matrices—one matrix per bone in the character, and 3) The animation system will also supply a list of morph target weights for the morph targets in the character model.

Each geometry channel that can be morphed will have an associated morph target channel for every morph target the model supports. This channel can be empty, if that morph target doesn't affect the base channel at all, or it can contain morph data. A format for the target data might be a low-precision delta from the original vertex position to the target position. The morph code might load the platform-dependent channel into an accumulation buffer, apply each active target to the buffer in sequence, and write the accumulation buffer back out into a new channel in a blend buffer.

A blend model might contain a channel override pointer for every channel in the base model. A NULL override pointer means that there was no morph targets applied to the base channel. A non-NULL override pointer points to the channel in the associated blend buffer. When a blend model is rendered, any channels that have been overridden are taken from the blend buffer instead of the base geometry in the main model.

Bake Model Feature

A new model can be “baked” from an existing one, collapsing selected swappable parts, swappable textures, and morph targets into a smaller model. The newly generated model need only contain the channels needed to render the smaller model, removing and collapsing the unneeded channels to save memory. The new texture library can also be collapsed to take up the smallest amount of VRAM or other memory possible given the textures that are swapped in.

Portable DNA Feature

As a customized player face/head/clothes/etc. is being created, or after customization is settled by the user, a dataset representing the changes, such as a character string, would be presented to the user or stored for the user. As an example, the various slider settings and customizations might be represented by a string of 20 to 40 characters, such as 36 characters. The string might dynamically change as the user customizes the player. Pressing a “done” key, or otherwise indicating completion, the dataset can be saved. This saved dataset can be provided to the user to allow for its reuse in another instance of the game or a different game. For example, the user might customize a player in a golf game and use it in another instance of that golf game to play with other players, or load it into a basketball game. Customizations could also be uploaded and transferred to other parties, such as over a network. Millions of combinations of customized players can be created by users of the game and then their “DNA” strings can be published on gaming sites and passed around.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

1. In a video game wherein a user playing the video game manipulates a player in playing the game, a method of customizing the player comprising:
obtaining a plurality of target visual objects representing a portion or all of the player;
receiving from the user a value indicative of relative weights among the plurality of target visual objects;
generating a customized player from a weighted combination of the plurality of target visual objects.

2. The method of claim 1, wherein the plurality of target visual objects is two target visual objects and the value indicative of the relative weights is a number representing the relative proportions of the two target visual objects that are combined to generate the customized player.

3. The method of claim 2, wherein the value is between zero and one, wherein zero represents a customized player generated from a first of the two target visual objects and one represents a customized player generated from a second of the two target visual objects.

4. The method of claim 2, wherein a valid range includes values les than zero and greater than one, wherein zero represents a customized player generated from a first of the two target visual objects and one represents a customized player generated from a second of the two target visual objects, values outside the range of zero and one representing overdriven images.

5. The method of claim 1, further comprising a step of fixing target visual objects and user values to form a customized player dataset that is a fixed model in that the memory occupied is comparable to the memory occupied by a noncustomized player model and in that the fixed model does not contain sufficient information to allow it to be customized as prior to the step of fixing.

6. The method of claim 1, further comprising a step of generating a dataset representative of customizations and independent of details of the target visual objects.

7. The method of claim 6, wherein the dataset representative of customizations is a string, the method further comprising presenting the string to the user.

8. The method of claim 6, further comprising a step of making the dataset available for output from the game for use in other instances of the game or other games, thereby allowing the user to port a customized character from one game to another game or another instance of the one game.

9. The method of claim 1, wherein the plurality of target visual objects represents a plurality of body shapes.

10. The method of claim 1, wherein the plurality of target visual objects represent a plurality of facial features.

11. The method of claim 1, wherein the plurality of target visual objects represent a plurality of skin types.

12. The method of claim 1, wherein the plurality of target visual objects represent a plurality of clothing elements.

13. The method of claim 1, wherein the plurality of target visual objects represent a plurality of accessories.

14. The method of claim 1, wherein the plurality of target visual objects represent one or more character features selected from the group of face shape, height, weight, skin color, skin texture, body build, particular sports figures' faces, clothing, hair, eyes, nose, mouth, lips, hands and feet.

15. The method of claim 1, wherein the plurality of target visual objects is two visual objects representing two face shapes as morph targets and the value indicative of relative weights is input using an input slider, where the resulting face feature of the character matches one of the morph targets when the input slider is at one extreme, matches the other morph target when the input slider is at the other extreme and is a combination of the morph targets when the input slider is between the extremes.

16. The method of claim 1, further comprising:
generating a plurality of values representative of differing feature weights;
automatically generating resulting customized characters using the differing feature weights; and
displaying the resulting customized characters to present the user with possibilities for user customization of characters.

17. A video game wherein a user playing the video game manipulates a player in playing the game, comprising:
a processor;
storage for shopping rules;
storage for shopping elements;
a real-time clock coupled to the processor for providing the processor one or more of a current time and a current date;
logic for presenting shopping elements to the user from the storage for shopping elements according to shopping rules from the storage for shopping rules, wherein at least one shopping rule provides a time restriction for at least one shopping element, the logic including instructions for comparing one or more of the current time and the current date against the time restriction and presenting the shopping element to the user if the time restriction is met and not presenting the shopping element to the user if the time restriction is not met.

18. The video game of claim 16, wherein the video game is a simulated golfing game, the shopping elements are pro shop elements for purchase by the player within the game and the time restrictions allow for purchase of shopping elements during a set of pro shop hours and do not allow for purchases outside that set of pro shop hours.

19. The video game of claim 16, wherein the shopping elements are seasonal items and the time restrictions control access to the shopping elements based on a time of year as indicated by the real-time clock.
